(19) United States
(12) Patent Application Publication
(10) Pub. No.: US 2003/0021864 A1
(43) Pub. Date: Jan. 30, 2003

(54) Coated chewing gum products and methods for making same

(76) Inventors: Lindell C. Richey, Lake Zurich, IL (US); Albert H. Chapdelaine, Naperville, IL (US); Phillip G. Schnell, Downers Grove, IL (US); Tomas M. Mindak, Itasca, IL (US); Christafor E. Sundstrom, Glen Ellyn, IL (US)

Correspondence Address: BELL, BOYD & LLOYD LLC, P. O. BOX 1135, CHICAGO, IL, 60690-1135, US

(21) Appl. No.: 09/681,692

(22) Filed: May 22, 2001

(51) Int. Cl. A23G 3/30

(52) U.S. Cl. 426/5

(57) ABSTRACT

The present invention provides a coated chewing gum product. The product comprises a gum center that includes a water-soluble portion and a water-insoluble portion. The water-insoluble portion comprises at least 50% by weight of the gum center. The gum center includes less than 5% by weight of bulk sweeteners. A coating substantially surrounds the gum center.

### BACKGROUND OF THE INVENTION

The present invention relates generally to confectionery products. More specifically, the present invention relates to coated chewing gum products and methods of making same.

It is, of course, known to make a variety of confectionery products. One such confectionery product is chewing gum. Confectionery products have been molded, extruded, or otherwise shaped into various forms over the years. For example, chewing gum has been formed into shapes such as flat sticks, cylinders, cubes, cigars, shredded chew, and the like. An example of a traditional shape for chewing gum is the gumball. Providing a confectionery product such as chewing gum in novel shapes or forms can lead to enhanced marketability of such product, particularly with younger consumers.

In addition to providing a variety of shapes and forms for chewing gum products, a considerable amount of developmental activities have involved improving the flavor release characteristics of chewing gum. One desired outcome is to prolong the release of flavor during the chew.

Not only is it desirable to extend flavor release, a further desired result is to increase the flavor perception. Increasing flavor perception to the consumer provides a more enjoyable chew. Additionally, increasing the level of flavor can also provide breath-freshening characteristics to the product.

As noted above, gumballs are well known in the confectionery industry as well as to consumers. Gumballs can comprise a chewing gum center that is coated with a hard shell. A product that is related to traditional gum balls are miniature coated pellets. Examples of such products are Chiclets and Mini-Chiclets. Such products have been sold for a number of years. However, a disadvantage of these miniature type chewing gum products is they tend to lose their flavor quickly during the chew. Further, at least some of these products do not provide the consumer with much flavor during the chew.

A number of attempts have been made at producing chewing gum having longer-lasting flavor and/or increased flavor perception. The inventors believe these attempts have not been entirely successful, at least with respect to coated chewing gum products that have a reduced size.

There is therefore a need for improved compositions and methods for providing coated chewing gum products and specifically, miniature chewing gum products, having improved flavor release and perception characteristics.

### SUMMARY OF THE INVENTION

The present invention provides improved coated chewing gum products as well as methods of making same. In this regard, the present invention provides coated chewing gum products that have an extended flavor release as well as increased flavor perception that can, in an embodiment, provide breath freshening characteristics. This is true even if the products are provided in a small or reduced size.

To this end, the present invention provides a coated chewing gum product. The product comprises a gum center that includes a water-soluble portion and a water-insoluble portion. The water-insoluble portion comprises at least 50% by weight of the gum center. The gum center includes less than 5% by weight of bulk sweeteners. A coating substantially surrounds the gum center.

In an embodiment, the coating comprises at least 50% by weight of the coated chewing gum product.

In an embodiment, the coating comprises at least 80% by weight of the coated chewing gum product.

In an embodiment, the gum center does not include any bulk sweeteners.

In an embodiment, the insoluble portion comprises at least 65% by weight of the gum center.

In an embodiment, the product has a spherical shape.

In an embodiment, the product has a pellet shape.

In an embodiment, the gum center includes 0.1 to 25% by weight flavor.

In an embodiment, the gum center is wax-free.

In an embodiment, the coating includes: at least 0.1% to about 12% flavoring; at least 0.05% to about 1.0% by weight artificial sweetener; and at least 0.1% to about 5% by weight dispensing agent.

In a further embodiment of the present invention, a coated chewing gum product is provided. The product comprises a gum center including a water soluble portion and a water insoluble portion, the water insoluble portion comprising at least 50% by weight of the gum center. The gum center includes a flavoring agent that comprises at least 0.1% by weight of the gum center and less than 5% by weight of a bulk sweetener. A coating substantially surrounds the gum center and comprises at least 50% by weight of the coated chewing gum product.

In yet another embodiment of the present invention, a method of improving flavor perception in a coated chewing gum product is provided. The method comprising the steps of providing a coated chewing gum product that includes a gum center that comprises at least 50% by weight gum base and less than 5% bulk sweeteners.

An advantage of the present invention is to provide an improved chewing gum product.

Additionally, an advantage of the present invention is to provide an improved method for making chewing gum products.

Still further, an advantage of the present invention is to provide a coated chewing gum product having increased flavor release characteristics.

Moreover, an advantage of the present invention is to provide a chewing gum product that has enhanced flavor perception.

Further, an advantage of the present invention is to provide a chewing gum product that provides improved breath freshening characteristics.

Furthermore, an advantage of the present invention is to provide a coated chewing gum product having reduced size but having improved flavor release characteristics.

Another advantage of the present invention is to provide an improved method for making coated chewing gum products having a reduced size.

Moreover, an advantage of the present invention is to provide an improved coated chewing gum product.

Additional features and advantages of the present invention will be described in and apparent from the detailed description of the presently preferred embodiments.

### DETAILED DESCRIPTION

The present invention provides improved chewing gum products as well as methods of manufacturing same. In the preferred embodiment set forth below, the present invention provides improved coated chewing gum products as well as methods of making same. The products have improved flavor release characteristics. Additionally, the products are designed to provide improved flavor perception as compared to similar type products. In an embodiment, this provides an improved breath freshening product.

The inventors have surprisingly discovered that by producing a gum composition that has a high level of base and little or no bulk sweetener a product is produced that has improved flavor perception during the chew. Such a product is especially advantageous for use with gumballs and reduced sized chewing products, especially coated products. Due to the small size of some reduced products, consumers are able to reload or add more products in their mouth as they chew the initial pieces. This offers a consumer the opportunity to control cud size, flavor, and/or freshness enhancement during the time period they chew.

In general, chewing gum compositions typically comprises a water-soluble portion and a water insoluble portion. The water insoluble portion is referred to as gum base.

The water insoluble gum base may typically contain any combination of elastomers, resins, fats and oils, softeners, and inorganic fillers. The gum base may or may not include wax. The insoluble gum base may constitute approximately 50 to about 95% by weight of the chewing gum, in an embodiment the gum base comprises 65 to about 75% by weight of the chewing gum.

Elastomer plasticizers that are used in the gum base may include, but are not limited to, natural rosin esters such as glycerol esters of partially hydrogenated rosin, glycerol esters of polymerized rosin, glycerol esters of partially dimerized rosin, glycerol esters of rosin, pentaerythritol esters of rosin, synthetics such as terpene resins derived from alpha-pinene, beta-pinene, and/or d-limonene, and any suitable combinations of the foregoing. The preferred elastomer plasticizers will vary depending on the specific application, and on the type elastomer which is used.

Fillers/texturizers that are used in the gum base may include magnesium and calcium carbonate, ground limestone, silicate types such as magnesium and aluminum silicate, clay, alumina, talc, titanium oxide, mono-, di-, and tri-calcium phosphate, cellulose polymers, such as wood, and combinations thereof.

Softeners/emulsifiers that are used in the gum base may include tallow, hydrogenated tallow, hydrogenated and partially hydrogenated vegetable oils, cocoa butter, glycerol monosterate, glycerol triacetate, lecithin, mono-, di- and triglycerides, acetylated monoglycerides, fatty acids (e.g., stearic, palmitic, oleic, and linoleic acids), and combinations thereof. Colorants and whiteners may include FD&C type dyes and lakes, fruit and vegetable extracts, titanium dioxide, and combinations thereof.

As noted above, the base may or may not include wax. An example of a wax-free gum base is disclosed in U.S. Pat. No. 5,286,500, the disclosure which is incorporated herein by reference.

Pursuant to the present invention the chewing gum contains little or no bulk sweeteners. Bulk sweeteners of the present invention comprise less than 5% by weight of the chewing gum center. In an embodiment, the chewing gum does not include any bulk sweeteners.

High intensity sweeteners may also be present in the chewing gum. When used, high intensity sweeteners may constitute between approximately 0.01% to about 5% and in an embodiment, approximately 0.015 to about 3% by weight of the chewing gum center. Such sweeteners may include, but are not limited to, aspartame, salts of acesulfame, alitame, saccharin and its salts, neotame, sucralose, cyclamic acid and its salts, glycyrrhizin, dihydrochalones, thaumatin, monellin, and the like, alone or in any combination.

Flavor should generally be present in the chewing gum in an amount within the range of approximately 0.1% to about 25% by weight of chewing gum, in an embodiment, approximately 3% to about 20%, and in a further embodiment, approximately 5% to about 15% by weight of the chewing gum. Flavoring agents may include essential oils, synthetic flavors or mixtures thereof including, but not limited to, oils derived from plants and fruits such as citrus oils, fruit oils, clove oil, oil of wintergreen, anise, menthol, and the like. Artificial flavoring agents and components may also be used in the flavor ingredient of the invention. Natural and artificial flavoring agents may be combined in any sensorally acceptable fashion.

Optional ingredients such as colors, emulsifiers, pharmaceutical agents and additional flavoring agents may also be included in the chewing gum.

In a preferred embodiment, the present invention provides a coated chewing gum product. The coating for the present invention may comprise approximately 50 to about 95% by weight of the entire coated product. In an embodiment approximately 80 to about 90% by weight of the gum product is coating. Sugar or sugarless sweeteners may also be used in the coating composition.

In a preferred embodiment, the present invention is utilized to produce a chewing gum product that is formed into miniature sized balls. The miniature sized balls are coated to provide a hard, surrounding shell. U.S. Pat. No. 5,667,824, the disclosure of which is incorporated herein by reference, discloses both methods and apparatus for configuring miniature, round gumballs. Other alternative processes, such as extrusion, cutting and tumbling, may be employed by those skilled in the art to produce round (spherical) centers. Of course, if desired, any shaped product can be produced. For example, in an embodiment, pellet shaped products are produced.

Once the gum center has been made and formed, the gum center is coated. The gum center can be coated or panned by conventional panning techniques to make a coated miniature ball gum. The bulk sweetener in the coating is very stable and highly water soluble, and can be easily added to a solution prepared for panning. The bulk sweetener may be combined with sucrose, other polyols, or used alone in solution as the coating on the gum center. Further, the bulk sweetener can also be added as a powder blended with other powders often used in some types of conventional panning procedures.

Conventional panning procedures generally use sucrose to coat. Recent advances in panning have allowed the use of other carbohydrate materials to be used in the place of sucrose for the coating. Some of these components include, but are not limited to, dextrose, maltose, zylitol, hydrogenated isomaltulose and other new polyols or combinations thereof. These materials may be blended with panning modifiers including, but not limited to, gum arabic, maltodextrins, corn syrup, gelatin, cellulose type materials like carboxymethyl cellulose, starch and modified starches, vegetable gums like alginates, locust bean gum, guar gum and talc. Antitack agents may also be added as panning modifiers, which allow the use of a variety of carbohydrates and sugar alcohols to be used in the development of new panned or coated gum products.

The coating that is used to produce the coated gum product may contain ingredients such as flavoring agents, artificial sweeteners, dispersing agents, coloring agents, film formers and binding agents. Flavoring agents contemplated in the present invention include those commonly known in the art such as essential oils, synthetic flavors or mixtures thereof, including but not limited to oils derived from plants and fruits such as citrus oils, fruit essences, peppermint oil, spearmint oil, other mint oils, clove oils, oil of wintergreen, anise, menthol, and the like. The flavoring agents may be added to the coating syrup in an amount such that the coating will contain from approximately 0.1% to about 12% by weight flavoring agent, and in an embodiment, from approximately 2.0% to about 6.0% by weight flavoring agent (based on dry solids).

Artificial sweeteners contemplated for the use in the coating include, but are not limited to, synthetic substances, saccharin, thaumatin, alitame, saccharin sales, aspartame, sucralose, and acesulfame K. The artificial sweetener may be added to the coating syrup in amount such that the coating will contain from approximately 0.05% to about 1.0% by weight artificial sweetener, and in an embodiment from approximately 0.30% to about 0.60% by weight artificial sweetener.

Dispersing agents are often added to a syrup that is used to produce the coating for the purpose of whitening and tack reduction. Dispersing agents contemplated by the present invention to be employed in the coating syrup include titanium dioxide, talc, or any other antistick compound. The dispersing agent may be added to the coating syrup in amounts such that the coating will contain approximately 0.1% to about 5.0% and in an embodiment from approximately 1.0% to about 2.0% by weight of the agent.

The coating can include coloring agents. These agents are typically added directly to the coating syrup in a dye or lake form. Coloring agents contemplated by the present invention include food quality dyes. Film formers likely added to the coating syrup include methylcellulose, gelatins, hydroxpropyl cellulose, hydroxyethyl cellulose, ethyl cellulose, carboxymethyl cellulose, and the like and in combinations thereof. Binding agents may be added either as an initial coating on the chewing gum center or may be added directly into the syrup. Binding agents contemplated by the present invention include gum arabic, aliginate, cellulose's vegetable gums, and the like.

In an embodiment, as noted above, the coating is initially present as a liquid syrup. In an embodiment, the syrup contains from approximately 30% to about 85% by weight of the coating ingredients previously described herein, and approximately 15% to about 70% by weight of a solvent such as water. In an embodiment, the hard coating process is carried out in a rotating pan. More sophisticated coaters such as those made by Driam and Dumoulin may also be employed.

A coating procedure for hard-coated gum products that can be utilized is disclosed in U.S. Pat. No. 5,536,511 the disclosure of which is incorporated herein by reference. Modifications can be made to this process to meet the needs of the product being coated.

Methods and apparatus for making the product of the present invention are disclosed in U.S. patent application Ser. No. ______ entitled “Process and Apparatus for Producing Miniature Gum Ball Centers Using an Underwater Pelletizer,” being filed herewith the disclosure of which in incorporated herein by reference.

### EXAMPLES

By way of example, and not limitation, examples of the present invention will now be given.

Table 1 lists gum center compositions having the following formulation:

TABLE 1
(% Wt.)

| | Example | Example | Example | Example | Example |
|---|---|---|---|---|---|
| Ingredient | 1 | 2 | 3 | 4 | 5 |
| Base | 70.50 | 64.90 | 67.50 | 72.00 | 59.00 |
| Talc | 18.00 | 11.75 | 23.00 | 16.00 | 14.00 |
| Atomite | — | 15.00 | — | — | 14.00 |
| Citric Acid | 5.00 | — | — | 4.00 | — |
| Malic Acid | — | — | — | 1.00 | — |
| Aspartame | 0.75 | 0.75 | 1.00 | — | 1.00 |
| Acesulfame K | 0.75 | — | 0.50 | 1.00 | 1.25 |
| Encapsulated | — | 0.75 | 1.00 | 1.00 | 0.75 |
| Acesulfame K | | | | | |
| Menthol | — | 1.00 | 1.00 | — | 2.00 |
| Cooling Agent | — | 0.85 | — | 1.00 | 2.00 |
| Flavor | 5.00 | 5.00 | 6.00 | 4.00 | 6.00 |
| Total: | 100.00 | 100.00 | 100.00 | 100.00 | 100.00 |

Table 2 lists coating formulas that can be used to coat the above-identified gum centers.

TABLE 2
(% Wt.)

| | Example | Example | Example | Example | Example |
|---|---|---|---|---|---|
| Ingredient | 6 | 7 | 8 | 9 | 10 |
| Maltitol | 85.60 | 79.75 | — | — | — |
| Xylitol | — | — | 81.70 | — | 82.85 |
| Sorbitol | — | — | — | 86.35 | — |
| Gum Arabic | 7.00 | 8.00 | — | 8.00 | 8.50 |
| Guar Gum | — | 5.00 | 9.70 | — | — |
| Malic Acid | — | — | — | 0.50 | 1.00 |
| Citric Acid | — | 1.25 | — | — | 2.00 |
| Titanium Dioxide | 1.50 | 1.25 | 1.00 | — | — |
| Talc | 0.45 | 0.25 | 0.30 | 0.50 | 0.20 |
| Carnauba Wax | 0.25 | 0.15 | 0.30 | 0.50 | — |
| Acesulfame K | — | 0.35 | — | — | 0.10 |
| Aspartame | 1.00 | — | — | 0.50 | 0.25 |
| Encapsulated | — | — | — | 0.55 | 0.10 |
| Aspartame | | | | | |
| Menthol | 0.50 | — | 1.00 | — | — |
| Cooling Agent | 0.20 | — | 1.00 | — | — |
| Flavor | 3.50 | 4.00 | 5.00 | 3.10 | 4.75 |
| Color | — | — | — | — | 0.25 |
| Total: | 100.00 | 100.00 | 100.00 | 100.00 | 100.00 |

Experiment No. 1

The formulations of Examples 2 and 6 were used to produce miniature coated gumballs. The final pellet product contained 60% by weight coating. These gumballs were tested in blind taste tests. The tests were conducted among gum users for flavor and breath freshening characteristics. Four gumballs were given to the participants for mastication. Overall, 56% of the participants rated the gum product as more breath freshening, and 45% rated the product having a longer lasting flavor as compared to other commercially available coated chewing gum products.

Some participants were allowed to “reload” (add gumballs to their mouth as they chewed the initial four pieces). The results showed that 59% said the product was more breath freshening and 47% said the product had longer lasting flavor compared to other gum products.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A coated chewing gum product comprising:
a gum center that includes a water soluble portion and a water insoluble portion, the water insoluble portion comprising at least 50% by weight of the gum center, the gum center including less than 5% by weight of bulk sweeteners; and
a coating that at least substantially surrounds the gum center.

2. The coated chewing gum product of claim 1 wherein the coating comprises at least 50% by weight of the coated chewing gum product.

3. The coated chewing gum product of claim 1 wherein the coating comprises at least 80% by weight of the coated chewing gum product.

4. The coated chewing gum product of claim 1 wherein the gum center does not include any bulk sweetener.

5. The coated chewing gum product of claim 1 wherein the insoluble portion comprises at least 65% by weight of the gum center.

6. The coated chewing gum product of claim 1 wherein the product has a spherical shape.

7. The coated chewing gum product of claim 1 wherein the gum center includes 0.1 to 25% by weight flavor.

8. The coated chewing gum product of claim 1 wherein the gum center is wax-free.

9. The coated chewing gum product of claim 1 wherein the coating includes:
at least 0.1% to about 12% flavoring;
at least 0.05% to about 1.0% by weight artificial sweetener; and
at least 0.1% to about 5% by weight dispensing agent.

10. A coated chewing gum product comprising:
a gum center including a water soluble portion and a water insoluble portion, the water insoluble portion comprising at least 50% by weight of the gum center, the gum center including a flavoring agent that comprises at least 0.1% by weight of the gum center and less than 5% by weight of a bulk sweetener; and
a coating that substantially surrounds the gum center and comprises at least 50% by weight of the coated chewing gum composition.

11. The coated chewing gum product of claim 10 wherein the gum center does not include any bulk sweetener.

12. The coated chewing gum product of claim 10 wherein the insoluble portion comprises at least 65% by weight of the gum center.

13. The coated chewing gum product of claim 10 wherein the product has a spherical shape.

14. The coated chewing gum product of claim 10 wherein the coating includes:
at least 0.1% to about 12% flavoring;
at least 0.05% to about 1.0% by weight artificial sweetener; and
at least 0.1% to about 5% by weight dispensing agent.

15. The coated chewing gum product of claim 10 wherein the product has a pellet like shape.

16. The coated chewing gum product of claim 10 wherein the gum center is sugarless.

17. A method of improving flavor perception in a coated chewing gum product comprising the step of providing a coated chewing gum product that includes a gum center that comprises at least 50% by weight gum base and less than 5% bulk sweeteners.

18. The method of claim 17 including the steps of coating a gum center with a syrup coating to produce the coated chewing gum product.

19. The method of claim 17 wherein the gum center does not include any bulk sweetener.

20. The method of claim 17 including the step of using a panning process to produce the coated chewing gum product.
